(19) United States
(12) Patent Application Publication
(10) Pub. No.: US 2026/0189416 A1
(43) Pub. Date: Jul. 2, 2026

(54) Method for 5G LAN Ethernet Multicast Group Management and Traffic Forwarding

(71) Applicant: Hong Kong Applied Science And Technology Research Institute Co., Ltd., Shatin (HK)

(72) Inventors: Min Liu, Sha Tin (HK); Jianjun Zhang, Shenzhen (CN); Liang Xia, Shenzhen (CN); Wei Li, Shatin (HK); Liang Dong, Tseung Kwan O (HK); Yau Yau Yolanda Tsang, North Point (HK)

(21) Appl. No.: 19/004,874

(22) Filed: Dec. 30, 2024

(51) Int. Cl. H04L 12/18; H04L 45/7453

(52) U.S. Cl. CPC H04L 12/18; H04L 45/7453

(57) ABSTRACT

A method of joining a UE to a multicast group in a 5G LAN. The method comprises, at a UPF of a 5G core network, performing the steps of processing a multicast group join request message received from the UE in the 5G LAN to obtain a Multicast Group IP address; converting the Multicast Group IP address into a multicast group MAC address; and joining the UE to the multicast group based on said multicast group MAC address.

### FIELD OF THE INVENTION

The invention relates to a 5G Local Area Network (LAN). In particular, the present invention relates to 5G LAN Ethernet multicast group management and traffic forwarding. More specifically, the invention relates to a method of joining a terminal such as a UE to a multicast group in a 5G LAN, releasing or removing a UE from the multicast group, and/or forwarding multicast packets to UEs in the multicast group.

### BACKGROUND OF THE INVENTION

5G LAN is a virtual LAN service built in a 5G network, through which a LAN with mobility can be assembled to meet, for example, production or office needs, etc. In a 5G network, the administrator can modify the data in the user database to contract services to specified terminal (UE) numbers, thus grouping them into a 5G LAN. 5G LAN capabilities provide industry users, for example, with support for wide-area mobile local area networks and VPN services including Ethernet Forwarding; Broadcast/Multicast; UE-to-UE Communication; and Group Management.

5G LAN supports Ethernet traffic, and 5G networks can directly transmit Layer 2 protocols. The User Plane Function (UPF) should recognize the Media Access Control (MAC) addresses of terminals and support the forwarding of Ethernet multicast traffic. The two-layer networking provided by 5G LAN enables industrial users to facilitate efficient communication and isolation between devices, meeting the special requirements of industrial communication and improving the intelligence and automation of industrial production. Multicast is widely used in industrial scenarios. This is because multicast/broadcast can achieve distributed control and management, thereby improving production efficiency and quality. 5G LAN supports multicasting, which can realize more efficient and reliable production line control and management.

Industry verticals have very low latency requirements for Ethernet multicast forwarding. Without an efficient 5G LAN multicast function, the 5G system cannot perform well in low-latency-sensitive 5G private networks, particularly in 5G factories. 3GPP specifications and existing solutions do not provide an efficient implementation method for 5G LAN multicast group management and forwarding. Therefore, there is a need, among other things, to implement a novel method for forwarding multicast traffic and managing multicast groups efficiently in 5G LANs.

### OBJECTS OF THE INVENTION

An object of the invention is to mitigate or obviate to some degree one or more problems associated with known methods of forwarding multicast traffic and managing multicast groups efficiently in 5G LANs.

The above object is met by the combination of features of the main claims; the sub-claims disclose further advantageous embodiments of the invention.

Another object of the invention is to provide a novel method and system of joining a UE to a multicast group in a 5G LAN.

A further object is to provide a novel method and system of a UE leaving a multicast group in a 5G LAN.

A yet further object of the invention is to provide a novel method of forwarding multicast packets to UEs in a multicast group.

One skilled in the art will derive from the following description other objects of the invention. Therefore, the foregoing statements of object are not exhaustive and serve merely to illustrate some of the many objects of the present invention.

### SUMMARY OF THE INVENTION

The invention provides a system and method for 5G LAN Ethernet multicast group management and traffic forwarding on the 5G data plane which is a key step for further supporting 5G network for smart manufacturing and the like.

In a first main aspect, the invention provides a method of joining a UE to a multicast group in a 5G LAN. The method comprises, at a UPF of a 5G core network, performing the steps of processing a multicast group join request message received from the UE in the 5G LAN to obtain a Multicast Group IP address; converting the Multicast Group IP address into a multicast group MAC address; and joining the UE to the multicast group based on said multicast group MAC address.

In a second main aspect, the invention provides a method of a UE leaving the 5G LAN multicast group comprising receiving at the UPF a UE multicast group leave request message, processing the multicast group leave request message to obtain a Multicast Group IP address, converting the Multicast Group IP address into a multicast group MAC address/Multicast Group identifier (ID), using the F-SEID and UE MAC address for mapping to the Multicast Group ID in the 5G multicast hash table and, if a mapping is found in the 5G multicast hash table, comparing the Multicast Group ID in the multicast hash table entry to the Multicast Group ID obtained from the preceding conversion step and, if the same, i.e., if matched, the UPF deletes the UE from the Multicast Group UE list sharing said mapped multicast group MAC address/Multicast Group ID. The UPF then deletes a corresponding hash key for the deleted UE from the 5G multicast hash table.

In a third main aspect, the invention provides a method of forwarding a multicast packet received from a UE at a 5G data plane of a 5G core network, the method comprising: receiving the multicast packet at a UPF in the 5G core network; the UPF configured to process the multicast packet to obtain a UE MAC address and UE F-SEID for said UE; the UPF configured to use the UE MAC address and UE F-SEID to look-up a 5G multicast hash table to find a Group UE list of an associated multicast group; and the UPF configured to duplicate the multicast packet and forward the multicast packet to other UEs in the associated multicast group.

In a fourth main aspect, the invention provides a network node in a 5G core network, the network node configured to perform a UPF of the 5G core network and configured to implement any of the methods of the first to third main aspects of the invention.

In a fifth main aspect, the invention provides a non-transitory computer-readable medium storing machine-readable instructions, wherein, when the machine-readable instructions are executed by a processor, they configure the processor to implement any of the methods of the first to third main aspects of the invention.

The summary of the invention does not necessarily disclose all the features essential for defining the invention; the invention may reside in a sub-combination of the disclosed features.

The foregoing has outlined fairly broadly the features of the present invention in order that the detailed description of the invention which follows may be better understood. Additional features and advantages of the invention will be described hereinafter which form the subject of the claims of the invention. It will be appreciated by those skilled in the art that the conception and specific embodiment disclosed may be readily utilized as a basis for modifying or designing other structures for carrying out the same purposes of the invention.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 illustrates the known 3GPP 5G standalone service-based architecture (SBA);

FIG. 2 illustrates a 5G LAN comprising a virtual LAN service provisioned on a 5G network;

FIG. 3 illustrates issues which arise in implementing 5G LAN multicast forwarding and 5G LAN multicast management;

FIG. 4 is a flow diagram of a method of joining a terminal (UE) to a multicast group in a 5G LAN in accordance with the invention;

FIG. 5 illustrates the structure of a 5G multicast hash table for a UE joining a multicast group in a 5G LAN in accordance with the invention;

FIG. 6 illustrates the 5G multicast hash table for a UE leaving a multicast group in a 5G LAN in accordance with the invention;

FIG. 7 illustrates multicast packet forwarding in a 5G LAN in accordance with the invention;

FIG. 8 shows a method and corresponding 5G multicast hash table for multicast packet forwarding in a 5G LAN in accordance with the invention; and

FIG. 9 is a flow diagram of the method of multicast packet forwarding in the 5G LAN in accordance with the invention.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the drawings may be implemented in various forms of hardware, software, or combinations thereof. These elements may be implemented in a combination of hardware and software on one or more appropriately programmed general-purpose devices, which may include a processor, memory, and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode, or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

The following description describes implementation of the present invention in a 5G communications network by way of example, but without limitation to implementation of the invention in suitable communications networks.

5G LANs are private cellular networks typically provided for enterprises that integrate into an organization's existing infrastructure. They provide high-speed wireless access and deterministic performance for mission-critical applications. 5G LANs can reduce the use of Ethernet cables, for example. A 5G LAN uses 5G terminal access capability and a private mobile LAN service to provide flexible communication services for group member terminals. 5G terminals, also known as 5G Customer Premise Equipment (CPE), enable devices like computers, laptops, and mobile phones to connect to the internet. 5G CPE devices receive 5G signals from a base station and then convert them into Wi-Fi or wired signals.

References herein to “UEs”, “CPEs” are to be taken to be references to “terminals” and vice-versa.

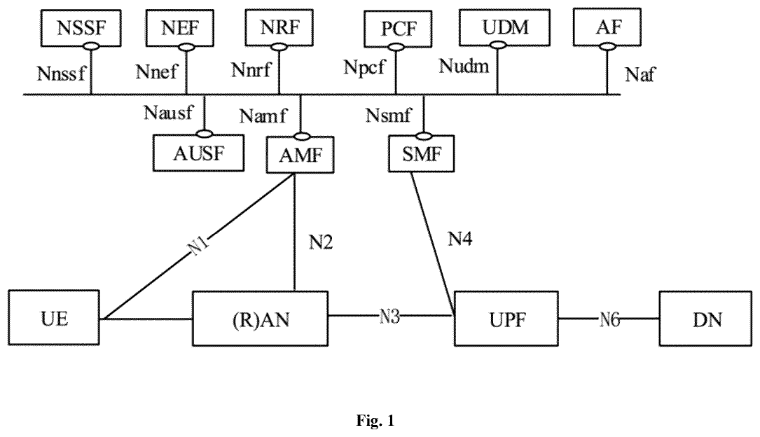

Referring to the drawings, FIG. 1 illustrates the known 3GPP 5G standalone service-based architecture (SBA) including the known interfaces between nodes and/or functional elements of the 5G network.

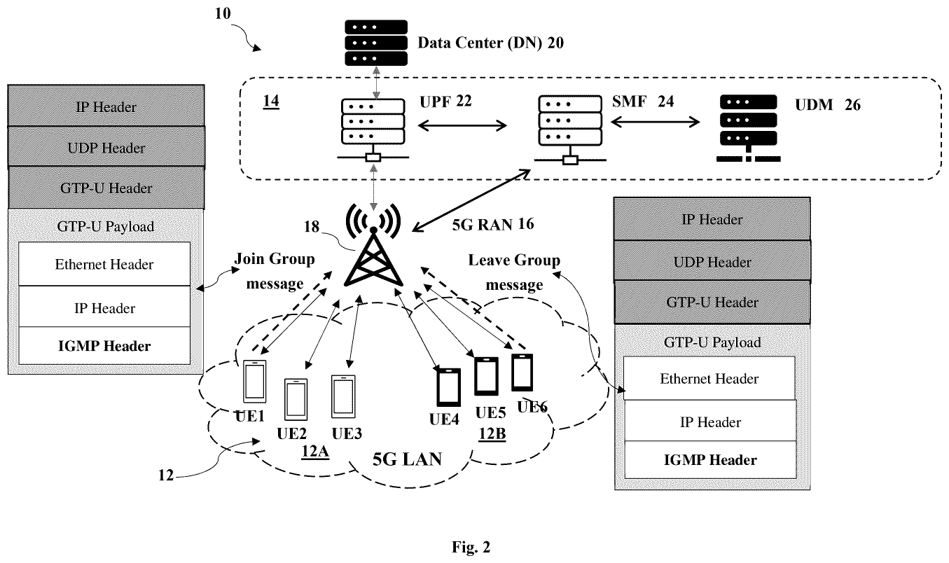

FIG. 2 illustrates a 5G network 10 including one or more virtual network (VN) Groups in a 5G LAN 12. Each VN Group comprises a virtual LAN service provisioned on the 5G network 10. In FIG. 2, UE1 to UE3 comprise a first VN Group 12A and UE4 to UE6 comprise a second VN Group12B. The first and second VN Groups12A, B are connected wirelessly to a core network 14 of the 5G network 10 by a radio access network (RAN) 16 including one or more base stations 18. The core network 14 may be connected to one or more data centers or data networks (DNS) 20. The core network 10 includes functional entities including a UPF 22, a session management function (SMF) 24, and a Unified Data Management (UDM) function 26. The functional entities may be implemented in core network nodes such as servers or the like configured to implement the respective functions through execution by one or more processors of machine-readable instructions stored on one or more non-transitory computer-readable media.

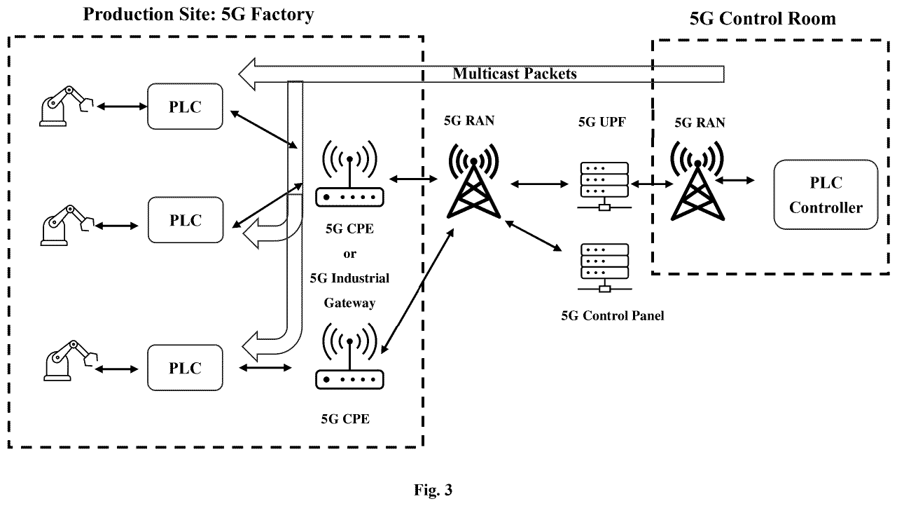

FIG. 3 illustrates an example embodiment of an enterprise based 5G LAN for managing and/or controlling industrial machines, e.g., programmable logic controllers (PLCs), and/or processes which give rise to issues in implementing 5G LAN multicast forwarding and 5G LAN multicast management.

Industry verticals have very low latency requirements for Ethernet multicast forwarding. Without an efficient 5G LAN multicast function, the 5G system cannot perform well in low-latency-sensitive 5G private networks, particularly in 5G factories. 3GPP specifications and existing solutions do not provide an efficient implementation method for 5G LAN multicast group management and forwarding.

The issues addressed by the present invention are to implement a novel method for forwarding multicast traffic and managing multicast group efficiently in 5G LAN and to implement an efficient 5G LAN multicast group management as will be hereinafter explained. The key embodiments of the invention addressing these issues comprise a novel method for a UE to join a 5G LAN multicast group, a novel method for a UE to leave a 5G LAN multicast group, and a novel method for multicast traffic forwarding.

The novel method of joining a UE to a 5G LAN multicast group comprises the UPF 22 processing a multicast group join request message received from the UE in the 5G LAN to obtain a multicast group internet protocol (IP) address, converting the Multicast Group IP address into a multicast group MAC address, and joining the UE to the multicast group based on said multicast group MAC address.

When the 5G core network 14 and the 5G RAN 16 are correctly setup and ready, the UE (UE1 in the case of FIGS. 2, 4 and 5) accesses the 5G RAN 16 and an Ethernet Protocol Data Unit (PDU) session is established in the UPF 22 for the UE. If the UE wishes to join a multicast group, the UE sends a multicast group join request message. As seen in FIG. 2, the multicast group join request message received by the UPF 22 from the UE comprises an Internet Group Management Protocol (IGMP) join group request message which is carried in a GPRS Tunneling Protocol for User Plane (GTP-U) payload accompanied by a GTP-U Header, a User Data Plane (UDP) Header, and an IP Header. An IGMP Header follows with an Ethernet Header transported to the UPF 22 by a GTP-U tunnel. The UPF 22 receives the IGMP group join request and, in response, adds an entry for the UE in a 5G Multicast Hash Table thereby joining the UE to the requested multicast group.

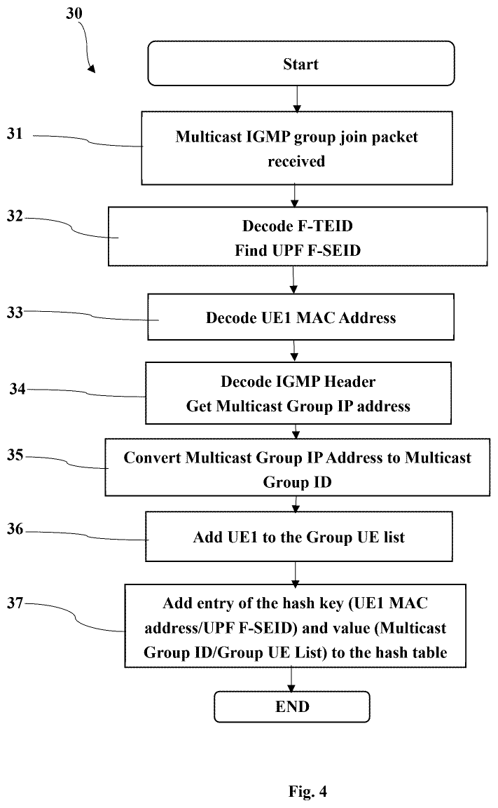

FIG. 4 illustrates in more detail the steps of the novel method 30 taken to join the UE to the requested multicast group.

In a first step 31 of the method 30, the UPF 22 receives the IGMP join group request message from the UE. In a next step 32 of the method 30, the UPF 22 decodes the Forwarding Tunnel Endpoint Identifier (F-TEID) for the UE in the GTP-U Header and finds the UPF Fully Qualified Session Endpoint Identifier (F-SEID). In a next step 33 of the method 30, the UPF 22 decodes the UE MAC address (UE1 MAC address in this example). Then, in a next step 34, the UPF 22 decodes the IGMP Header to obtain the Multicast Group IP address. In a following step 35, the UPF 22 converts the Multicast Group IP address into a multicast group MAC address and sets it as the Multicast Group identifier (ID). In a next step 36, based on the multicast group MAC address/Multicast Group ID, the UPF 22 adds the UE (UE1) to the multicast Group UE List. Then, in a final step 37 of the method 30, the UPF 22 adds a hash key and a value to the 5G Multicast Hash Table.

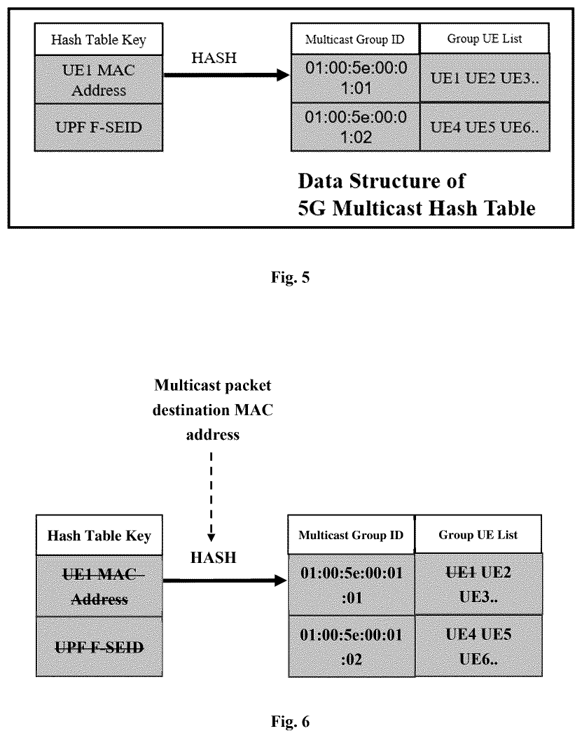

FIG. 5 shows a structure of the 5G multicast hash table for the UE joining the multicast group in the 5G LAN. The hash key is based on a combination of the UE MAC address and UPF F-SEID. The value comprises the Multicast Group ID/Group UE List.

The step of converting the Multicast Group IP address into a multicast group MAC address and setting it as the Multicast Group ID preferably comprises the following sub-steps. A first sub-step comprises converting the Multicast Group IP address to a binary string of bits. For example, where the Multicast Group IP address comprises the address 239.0.1.1, the binary bit string comprises 11101111.00000000.00000001.00000001. A next sub-step comprises extracting the last 23 bits, i.e., the underlined bits shown here 11101111.00000000.00000001.00000001. Then in a next sub-step, the last 23 binary bits are appended to binary bits comprising fixed bits of a known MAC address prefix reserved for multicasting. The fixed bits of the MAC address prefix reserved for multicasting comprise the 25 binary bits 00000001.00000000.01011110.0. Consequently, the resultant string of binary bits comprises 00000001.00000000.01011110.00000000.00000001.00000001. In a next sub-step, the resultant string of binary bits is converted to hexadecimal to provide the multicast group MAC address that is used when transmitting multicast traffic packets to the UEs comprising the Group UE list of the multicast group. In this example, the hexadecimal form of the multicast group MAC address is HEX: 0x0100.5E00.0101 as seen in FIG. 5. This is the MAC address that will be used when transmitting to group 239.0.1.1, and it is also the Multicast Group ID in the 5G Multicast Hash Table.

The novel method of a UE leaving the 5G LAN multicast group comprises receiving at the UPF 22 a UE multicast group leave request message, processing the multicast group leave request message to obtain a Multicast Group IP address, converting the Multicast Group IP address into a multicast group MAC address/Multicast Group ID, using the F-SEID and UE MAC address for mapping to the Multicast Group ID in the 5G multicast hash table and, if a mapping is found in the 5G multicast hash table, comparing the Multicast Group ID in the multicast hash table entry to the Multicast Group ID obtained from the preceding conversion step and, if the same, the UPF 22 deletes the UE from the Multicast Group UE list sharing said mapped multicast group MAC address/Multicast Group ID. The UPF 22 then deletes a corresponding hash key for the deleted UE from the 5G multicast hash table.

As seen in FIG. 2, the multicast group leave request message received by the UPF 22 from the UE has a same structure as the multicast group join request message.

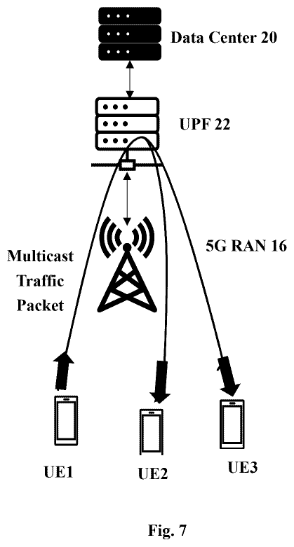

More specifically, the method of a UE leaving the multicast group comprises the following steps. In a first step, if the UE (e.g. UE1) wishes to leave the multicast group, the UE sends an IGMP leave group request message to the UPF 22 with the IGMP header following with IP/Ethernet Header transport by GTP-U tunnel. In a next step, the UPF 22 decodes the F-TEID in the GTP-U Header and finds the UPF F-SEID. In a next step, the UPF 22 decodes the Ethernet Header to obtain the UE MAC address. Following this, in a next step, the UPF 22 decodes IGMP Header to obtain the Multicast Group IP address and then converts the Multicast Group IP Address into the multicast group MAC Address and derives the Multicast Group ID therefrom. In a next step, the UPF 22 uses the UPF F-SEID and the UE MAC Address as a key to map to the Multicast Group ID from the 5G Multicast Hash Table to check if the Multicast Group ID from the prior step is the same as the Multicast Group ID from the 5G Multicast Hash Table. If the mapped Multicast Group IDs are the same, the UPF 22 deletes the UE (UE1) entry from the Group UE list for the corresponding multicast group and then deletes the respective hash key entry in the 5G Multicast Hash Table as can be seen in FIG. 6.

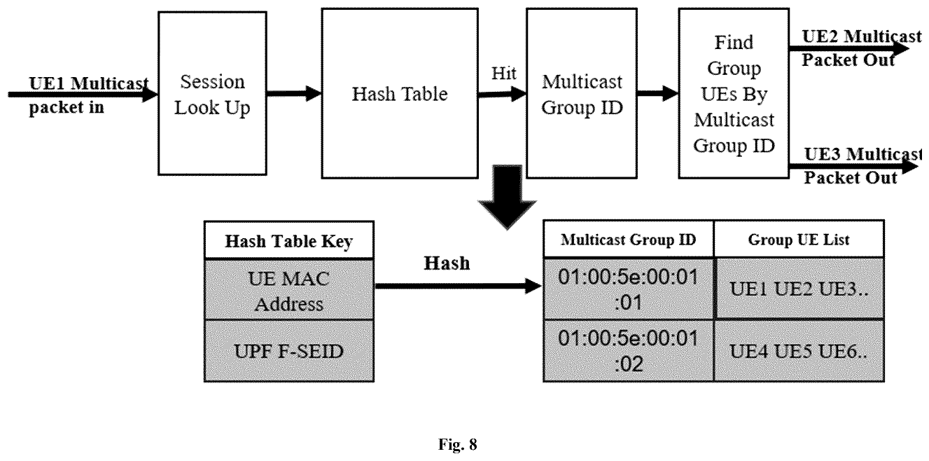

As illustrated in FIG. 7, the novel method of multicast traffic forwarding comprises, upon receiving a multicast packet from the UE on a 5G data plane of the 5G core network, the UPF 22 uses the UE MAC address and UE F-SEID as a hash key to map to a Multicast Group ID in the 5G multicast hash table and, if the hash key maps to a Multicast Group ID, the UPF 22 duplicates the multicast packet and forwards the multicast packet to other UEs in the Multicast Group UE list sharing said mapped Multicast Group ID. The UPF 22 obtains the UE MAC address and UE F-SEID from the multicast packet received from the UE on the 5G data plane.

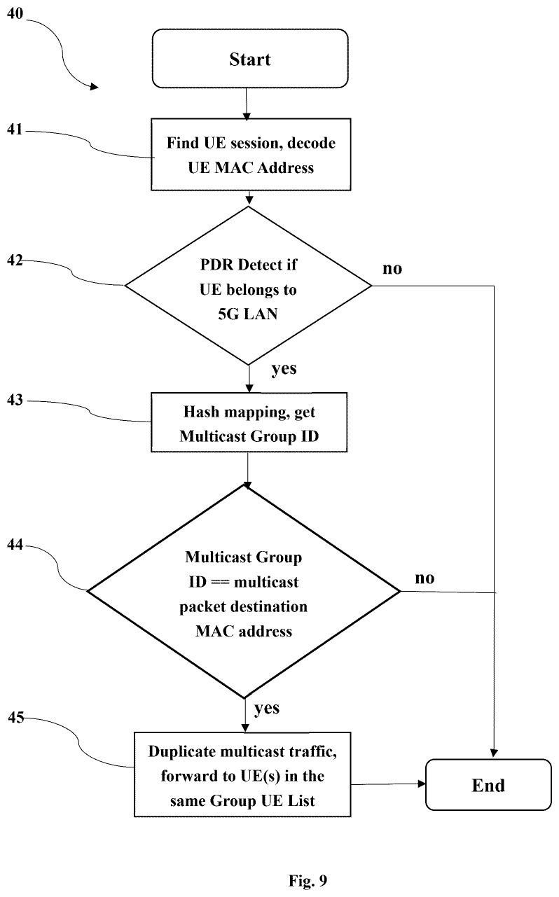

FIG. 8 illustrates an embodiment of the method of multicast traffic forwarding with the corresponding 5G Multicast Hash Table. FIG. 9 comprises a flow diagram of a more detailed version of the method 40 illustrated by FIG. 8.

In a first step 41 of the method 40 of FIG. 9, the UPF 22 receives the multicast Ethernet packet from, for example, UE1, decodes the F-TEID in the GTP-U Header to obtain the UPF F-SEID and then the UPF 22 decodes the UE (UE1) MAC address. In a next optional step 42, the UPF performs a Packet Detection Rule (PDR) detection to check if the UE belongs to the 5G LAN. If not, the method is terminated. If yes, then, in a next step 43, the UPF 22 uses the UE MAC address and UPF F-SEID as a hash key to map to the 5G Multicast Hash Table and obtain the Multicast Group ID. In a next step 44, the UPF checks if the obtained Multicast Group ID is the same as the multicast packet destination of the MAC address and, if not, the method is terminated. However, if yes, then, in a next step 45, the UPF 22 duplicates the multicast Ethernet packet and forwards the multicast Ethernet packet to the or any UEs which are in the same Multicast Group UElist, e.g., UE2 and UE3 in the example of FIGS. 7 and 8.

The invention provides an apparatus and a method for 5G LAN Ethernet multicast group management and traffic forwarding on 5G data plane, the method for joining a 5G LAN multicast group comprising the steps of: receiving the 5G LAN user configurations configured from the UDM on SMF; establishing an up Ethernet PDU session for the UE on UPF; accessing the 5G LAN network with the Ethernet PDU session from UE; on receiving an IGMP multicast group join request from the UE, the UPF decodes the IGMP message; and the UPF adds an entry in the 5G Multicast Group Hash Table on UPF.

The UDM or Unified Data Repository (UDR) may store key 5G LAN user data including VN Group ID, data network name (DNN), Single Network Slice Selection Assistance Information (SNSSAI), and group members, etc.

The SMF may request 5G LAN user data from the UDM on the N10 interface by using the HTTP/2 protocol.

The SMF may send Session Establishment Request with Ethernet PDN type to the UPF by the N4 interface through the Packet Forwarding Control Protocol (PFCP) protocol, and then the UPF may establish the Ethernet PDU Session for the 5G LAN UE.

The UPF preferably receives the IGMP join request encapsulated by GTP-U from the UE on the established Ethernet PDU Session from the N3 interface, then decodes GTP-U encapsulation, and finds the F-TEID in the GTP-U header.

Preferably, the UPF further decodes the UE MAC address in the Ethernet Header and the Multicast Group IP address in the IGMP Header of the GTP-U payload.

The UPF may lookup the PFCP session by using the F-TEID.

Preferably, the UPF converts the Multicast Group IP decoded from the IGMP Header decapsulated from the GTP-U packet to the Multicast Group ID for the 5G LAN group management.

The UPF may first convert the Multicast Group IP address to binary, take the last 23 bits and add it to the 25 bits of the well-known multicast MAC prefix, then convert it to HEX to get the Multicast Group ID.

The UPF adds a new entry in the 5G Multicast Hash Table, with the hash table key as the combination of the UE MAC address and the UPF F-SEID and the hash table entry as the Multicast Group ID and Group UE List.

The invention provides an apparatus and a method for 5G LAN Ethernet multicast group management and traffic forwarding on 5G data plane, the apparatus configured to implement the method for leaving the 5G LAN multicast group comprising the steps of: accessing the 5G LAN network with the Ethernet PDU Session on the UE; on receiving an IGMP multicast group leave request from the UE, the UPF decodes the IGMP message and then deletes the entry in the 5G Multicast Group Hash Table on the UPF.

The UPF may receive the IGMP leave request encapsulated by GTP-U from the UE on the established Ethernet PDU Session from the N3 interface, then decodes the GTP-U encapsulation, and finds the F-TEID in the GTP-U Header.

The UPF may further decode the UE MAC address in the Ethernet header and the Multicast Group IP address in the IGMP header of the GTP-U payload.

The UPF preferably lookups the UPF F-SEID by using the F-TEID.

The UPF preferably converts the Multicast Group IP address decoded from the IGMP Header decapsulated from the GTP-U packet to the Multicast Group ID for the 5G LAN group management.

The UPF preferably first converts the Multicast Group IP to binary bits, takes the last 23 bits and add these to the 25 bits comprising the well-known multicast MAC prefix, then convert the resulting bit string to HEX to get the Multicast Group ID.

The UPF uses the UPF F-SEID and the UE MAC address to lookup the entry in the 5G Multicast Hash Table and compares the Multicast Group ID in the entry to the Multicast Group ID of the preceding paragraph.

The UPF deletes the UE from the Group UE list in the entry from the 5G Multicast Hash Table if the Multicast Group IDs match.

The invention provides an apparatus and a method for 5G LAN Ethernet multicast group management and traffic forwarding on 5G data plane, supports multiple UPF deployments, and allows multicast group traffic to be transmitted within one UPF. The method for traffic forwarding comprises the steps of: accessing the 5G LAN network with the Ethernet PDU Session on the UE; on receiving a multicast packet from the UE, the UPF decodes the GTP-U message; the UPF finds the Group UE list in the 5G Multicast Hash Table; the UPF duplicates the multicast group traffic packet; and the UPF forwards the multicast group traffic packet to the other UEs in the same Group UE list.

The UPF preferably receives the Multicast packet encapsulated by GTP-U from the UE on the established Ethernet PDU Session from the N3 interface, then decodes the GTP-U encapsulation, and finds the F-TEID in the GTP-U header.

The UPF preferably lookups the UPF F-SEID by using the F-TEID.

The UPF preferably decodes the UE MAC address in the Ethernet header and the Multicast Group IP address in the IGMP header of the GTP-U payload.

The UPF preferably uses the UPF F-SEID and the UE MAC address to lookup the entry in the 5G Multicast Hash Table and finds the Group UE list in the 5G Multicast Hash Table.

The UPF duplicates the multicast traffic for all other UEs in the same multicast group.

The data structure of the 5G Multicast Hash Table preferably comprises a hash key consisting of the UE MAC and the UPF F-SEID and a value consisting of the Multicast group ID and the Group UE list belonging to the same multicast group.

The invention also provides a non-transitory computer-readable medium storing machine-readable instructions, wherein, when the machine-readable instructions are executed by a processor, they configure the processor to implement the method of any one of the appended method claims.

The apparatus described above may be implemented at least in part in software. Those skilled in the art will appreciate that the apparatus described above may be implemented at least in part using general purpose computer equipment or using bespoke equipment.

Here, aspects of the methods and apparatuses described herein can be executed on any apparatus comprising the communication system. Program aspects of the technology can be thought of as “products” or “articles of manufacture” typically in the form of executable code and/or associated data that is carried on or embodied in a type of machine-readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible non-transitory “storage” media, terms such as computer or machine “readable medium” refer to any medium that participates in providing instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A method of joining a user equipment (UE) to a multicast group in a 5G local area network (LAN), the method comprising:
at a network node configured to perform a user plane function (UPF) of a 5G core network, performing the steps of:
processing a multicast group join request message received from the UE in the 5G LAN to obtain a multicast group internet protocol (IP) address;
converting the Multicast Group IP address into a multicast group media access control (MAC) address;
joining the UE to the multicast group based on said multicast group MAC address.

2. The method of claim 1, wherein the multicast group MAC address is set as the Multicast Group identifier (ID), and the UE is added to the Multicast Group UE list.

3. The method of claim 2, wherein a hash table key based on a MAC address of the UE is added to a 5G multicast hash table for multicast groups.

4. The method of claim 3, wherein the hash table key based on the MAC address of the UE is based on a combination of the UE MAC address and a Fully Qualified Session Endpoint Identifier (F-SEID) obtained from a Protocol Data Unit (PDU) session established by the UPF for the UE.

5. The method of claim 4, wherein a hash table entry comprising the Multicast Group ID and the Multicast Group UE list is added to the 5G multicast hash table for the multicast groups.

6. The method of claim 1, wherein the step of converting the Multicast Group IP address into the multicast group MAC address comprises:
converting the Multicast Group IP address to a string of binary bits;
selecting a predetermined number of binary bits in a latter part of the string;
appending the selected binary bits to a string of binary bits comprising fixed bits of a MAC address prefix reserved for multicasting;
converting the resulting string of binary bits to hexadecimal to provide the multicast group MAC address that is used when transmitting multicast traffic packets to the UEs comprising the Group UE list of the multicast group.

7. The method of claim 6, wherein the predetermined number of binary bits selected from the latter part of the string of binary bits comprising the Multicast Group IP address comprise a last 23 binary bits of said string and wherein said selected 23 binary bits are added to 25 binary bits comprising the fixed bits of the MAC address prefix reserved for multicasting in the 5G LAN.

8. The method of claim 5, wherein, upon receiving a multicast packet from the UE on a 5G data plane of the 5G core network, the UPF uses the UE MAC address and UE F-SEID as a hash key to map to a Multicast Group ID in the 5G multicast hash table and, if the hash key maps to a Multicast Group ID, the UPF duplicates the multicast packet and forwards the multicast packet to other UEs in the Multicast Group UE list sharing said mapped Multicast Group ID.

9. The method of claim 8, wherein the UPF obtains the UE MAC address and UE F-SEID from the multicast packet received from the UE on the 5G data plane.

10. The method of claim 8, wherein, upon receiving the multicast packet from the UE on a 5G data plane, the UPF determines if the UE belongs to the 5G LAN and, if not, terminates the process.

11. The method of claim 5, further comprising:
receiving at the UPF a UE multicast group leave request message;
processing the multicast group leave request message to obtain a Multicast Group IP address;
converting the Multicast Group IP address into a multicast group MAC address/Multicast Group ID;
using the F-SEID and UE MAC address for mapping to the Multicast Group ID in the 5G multicast hash table and,
if a mapping is found in the 5G multicast hash table, comparing the Multicast Group ID in the multicast hash table entry to the Multicast Group ID obtained from the preceding conversion step and,
if the Multicast Group ID in the multicast hash table entry matches to the Multicast Group ID obtained from the preceding conversion step, the UPF deletes the UE from the Multicast Group UE list sharing said mapped multicast group MAC address/Multicast Group ID.

12. The method of claim 11, wherein the UPF deletes a corresponding hash key for the deleted UE from the 5G multicast hash table.

13. A method of forwarding a multicast packet received from a UE at a 5G data plane of a 5G core network, the method comprising:
receiving the multicast packet at a UPF in the 5G core network;
the UPF configured to process the multicast packet to obtain a UE MAC address and UE F-SEID for said UE;
the UPF configured to use the UE MAC address and UE F-SEID to look-up a 5G multicast hash table to find a Group UE list of an associated multicast group; and
the UPF configured to duplicate the multicast packet and forward the multicast packet to other UEs in the associated multicast group.

14. A network node in a 5G core network, the network node configured to perform a user plane function (UPF) of the 5G core network and configured to:
process a multicast group join request message received from a UE located in a 5G LAN to obtain a multicast group internet protocol (IP) address, the 5G LAN connected to the 5G core network via a radio access network (RAN);
convert the Multicast Group IP address into a multicast group media access control (MAC) address; and
join the UE to the multicast group based on said multicast group MAC address.
